(19) United States
(12) Patent Application Publication
(10) Pub. No.: US 2005/0060135 A1
(43) Pub. Date: Mar. 17, 2005

(54) Method and device for automatic association of data elements in modeling of a technical system

(75) Inventors: Wolfgang Gauckler, Kirchheim/Teck (DE); Herbert Gorl, Gemunden (DE); Werner Hoffmann, Herzogenaurach (DE); Gotz Kogel, Stuttgart (DE); Stepan Schischmanjan, Stuttgart (DE)

Correspondence Address: Henry M. Feiereisen, Suite 4714, 350 Fifth Avenue, New York, NY, 10118, US

(73) Assignee: SIEMENS AKTIENGESELLSCHAFT, Munchen (DE)

(21) Appl. No.: 10/697,786

(22) Filed: Oct. 23, 2003

(30) Foreign Application Priority Data
Sep. 24, 2003 (DE) 103 44 368.1
Oct. 23, 2002 (DE) 102 49 515.7

(51) Int. Cl. G06F 9/45

(52) U.S. Cl. 703/22

(57) ABSTRACT

A technical system is described by several abstract or concrete models which have a mutual relationship. Information/attributes can be associated with model elements and “inherited” through these relationships. While the approach can basically be applied to different types and models of machines, it is described more particularly for hierarchical component models. Model elements in these models are referred to as components, assemblies, etc.

### CROSS-REFERENCES TO RELATED APPLICATIONS

This application claims the priority of German Patent Applications, Serial Nos. 102 49 515.7, filed Oct. 23, 2002, and 103 44 368.1, filed Sep. 24, 2003, pursuant to 35 U.S.C. 119(a)-(d), the disclosure of which is incorporated herein by reference.

### BACKGROUND OF THE INVENTION

The present invention relates to a method and a device for automatically associating data elements in modeling a technical system formed of a plurality of components, e.g. a technical machine, a technical device, a technical facility (hereinafter referred to as “technical system”) based on models.

Models of technical system make it possible to structure data elements by associating information, such as the data elements, to individual components of the technical system, and enable access to the data elements by selecting the corresponding components (also referred to as model element). In general, a technical system can be described by a model, for example a hierarchical component model or a hierarchical functional model. A component or a model element can appear several times. The corresponding information is uniquely and explicitly associated with each component in form of the data element.

Separate models are set up for modeling different technical systems of essentially the same type, such as a machine tool, that can be configured with a single spindle or with both a work spindle and a tail spindle, or for example a level gauge which can be implemented as an ultrasound sensor, and also as a float. In other words: if several customized machine configurations exist for a technical system, e.g. a machine tool, then a simple model approaches require two different models to be set up and the data elements in both models to be associated with the components. This makes the configuration of such models particularly complex. The applicant is not aware of a solution for the afore-described problem. The problem has until now mostly been avoided by investing more resources to produce specific, independent models.

It would therefore be desirable and advantageous to provide a particularly simple method for automatically associating data elements in automatic modeling, which obviates prior art shortcomings.

### SUMMARY OF THE INVENTION

According to one aspect of the invention, a method for modeling a technical system with a plurality of technical components, includes the steps of providing data elements of a plurality of models which have a pre-definable mutual relationship in equivalent, superior and/or inferior levels, and based on the mutual relationship, automatically associating a data element of a model located at a superior level with another model that has a pre-definable relationship with a model at an equivalent or inferior level.

The invention is a based on the concept that each concrete technical system, such as a machine, a device, a facility, is composed of a plurality of individual units in the form of components, assemblies, functional elements, sensors and the like. Each such component can be separately described based on characteristic information or data elements, such as dimensions, operating parameters, properties, etc. Additional characteristic data elements can be, for example, measurements and weights as well as functions, such as a valve lift or the power consumption of a motor, as well as additional information or references to such additional information, for example handbooks, installation manuals, associated software, etc. Preferably, each description of such component based on the corresponding associated data element or on several associated data elements forms a data set.

A technical system is formed from the totality of all components by selecting and connecting several components. The totality of all components which cannot only form the corresponding technical system, but also another identical technical system, includes, for example, all components of a product line or of a distributor of technical systems, which can include components manufactured or distributed by the distributor himself, as well as components that are controlled by the components produced or distributed by the distributor.

Optionally, a subset of components required for a concrete technical system or partial system is selected from the totality of all components. This subset of components is also referred to as a parts list or component list, which describes an application-specific and hence real technical system. The component list includes, for example, all those components, such as one or several controllers, actuators and sensors for controlling and/or monitoring the technical system and the technical process on which the technical system is based, as well as the components on which the technical system is based, such as drives, valves, reactors, etc.

For modeling a technical system, several additional models are provided which include data elements as a description. The technical system itself as well as the corresponding component are described by the data elements of at least one model. The models are preferably subdivided into parent models and/or application-specific models. The term parent model in particular refers to a type of a technical system and/or a technical component that is sometimes referred to as a generic model. For example, a “power plant” can be defined as a parent model of a technical system, wherein the parent model “power plant” can again be subdivided hierarchically in additional sub-parent models until an elemental parent model for an elemental technical system is reached. Exemplary elemental technical systems for the exemplary technical system “power plant” are, for example, “coal-fired power plant”, “nuclear power plant”, “gas and steam turbine plant”, which are each described by an associated elemental parent model.

A parent model of a technical component can, for example, refer to a machine or an actuator drive. The parent model of a “machine” can in turn include sub-parent models, such as “machine tool”, “maintenance and cleaning machine”, which can be further hierarchically subdivided until a parent model for an elemental component is reached. In other words, parent models or generic models are abstract models of a technical system and/or a technical component, which are hierarchically configured at several levels.

An abstract parent model or generic model is particularly provided for including all the information or data elements about the corresponding component and/or about the associated technical system.

In order to further describe the different characteristics or properties of the abstract components or assemblies (also referred to as a basic or parent components or generic components), an identification model (also referred to as expression model) is associated with the components. The identification model is preferably used to describe the component in greater detail based on characteristic information or data elements, such as dimensions, functions, operating parameters, properties, weight, functionality, etc.

According to another feature of the present invention, the parent models of the components and/or the technical system can be combined arbitrarily, for example depending on the interaction possibilities between the components of the technical system. These combinations of parent models of the parent components or the parent system or referred to as relationships.

According to another feature of the present invention, application-specific models for the concrete technical component and/or the concrete technical system may be provided in addition to the parent models for building a concrete technical component or a concrete technical system. Depending on the type and configuration of the application-specific models, a possible application-specific model, for example, for a component or a system can include the number of elements required for implementing the component and/or the system, for example in form of a parts list. An additional application-specific model can be defined as the delivery quantity of the concrete technical component and/or the technical system in the form of a packing list (also referred to as installation parts list).

In other words: several models are used for modeling a concrete technical component and/or a concrete technical system based on several components, wherein the models are related to each other in equivalent, superior and/or inferior levels.

Depending on the type and configuration as well as the hierarchical structure, the data element representing a component or a technical system can be directly associated with the corresponding model—parent model and/or application-specific model—at the corresponding level and stored accordingly. In a preferred embodiment for simple and rapid modeling, the data element is associated with the model which is located in the hierarchy at a superior, in particular at the highest level, or in an inferior, in particular at the lowest level, so as to best utilize the available memory, but also for rapid retrieval.

By modeling the technical system based on the relationships between the different models, the data element of a model at a superior level is automatically associated with another model at an equivalent and/or a inferior level relative to this model, and vice versa. In other words, each data element is advantageously only associated with a single model. Depending on the modeling process, the corresponding data element can be associated only with a single parent model of all the parent models or with a single application-specific model of all application-specific models or can include all models and be associated with a single model—a parent model or an application specific model. In this way, the data element is stored only once, so that the attributes of the data element can be easily and safely changed or actualized. Change sand actualization have to be performed only once for all affected models.

In other words: a concrete technical system is modeled based on several parent models or generic models, in particular parent models of components such as generic components, generic assemblies and/or combinations of generic components and assemblies which are placed in a relationship at equivalent, superior and inferior levels.

Associations of data elements, such as information or characteristics of model elements, e.g. the components, are advantageously referenced and inherited by using the relationships. The approach can generally be applied to different model types; in the present practice, a hierarchical model with a tree structure is described. Alternatively, a network model or another type of model can also be employed. The model elements include as components, for example, building blocks, assemblies, etc.

Suitably, a concrete elemental relationship, in particular a structural relationship between one of the parent models and one of the application-specific models is created starting with a particular application-specific model, and associated with this application-specific model. Depending on the modeling, at least one additional parent model and/or an additional application-specific model of an additional component and/or of a technical system is automatically created in an additional step, after the relationship has been associated with the corresponding models, in particular with their systems and/or components based on a plurality of models, in particular of parent model and/or application-specific models of one or several components and their relationships. Alternatively, a parent model of a technical system can be created based only on parent models of one or more components.

According to another aspect of the invention, a device for automatically associating data elements during modeling of a technical system, includes a plurality of components based on models which have a mutual relationship in equivalent, superior and/or inferior levels, a first model-related memory for storing the models, and a second data-related memory for storing the data elements. At least one relationship is associated with the models stored in the first model-related memory, based on which the corresponding data element that is stored in the second data-related memory is associated with a model on a superior level. Based on a pre-definable relationship, the corresponding data element of a model on a superior level is automatically associated with another model that has a relationship with this model and is located on an equivalent or inferior level.

According to another feature of the present invention, at least one program code means for generating and storing the respective relationship between the at least two models may be provided. In addition, preferably a program code means for referencing and storing the data element representing the relationship is provided. A program code means can be used, for example, in connection with a database to link corresponding data fields. For a structured storage of the data and models, the first model-related memory is subdivided into a memory for parent models and a memory for application-specific models.

The present invention is able to significantly reduce the setup requirements for modeling a technical system formed of several components. If documents and/or information of several concrete machines belonging to the same production series or to different production series are to be associated as data elements with a parts list, then the entire process needs not be performed for each individual machine and for each individual component. Many associations can be automatically generated based on the model hierarchy and the association of the data element with the highest or lowest model and including a reference to the other models requiring this particular data element, because information can be generalized and can be again associated with concrete components by using relationships between the models.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of several models for modeling a technical system formed of several components;

FIG. 2 shows an exemplary diagram for performing a diagnosis of a technical system; and

FIG. 3 is a schematic diagram for using models in a diagnostic system for a technical system.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “Method and Device for Computer-Aided Analysis of a Technical System”.

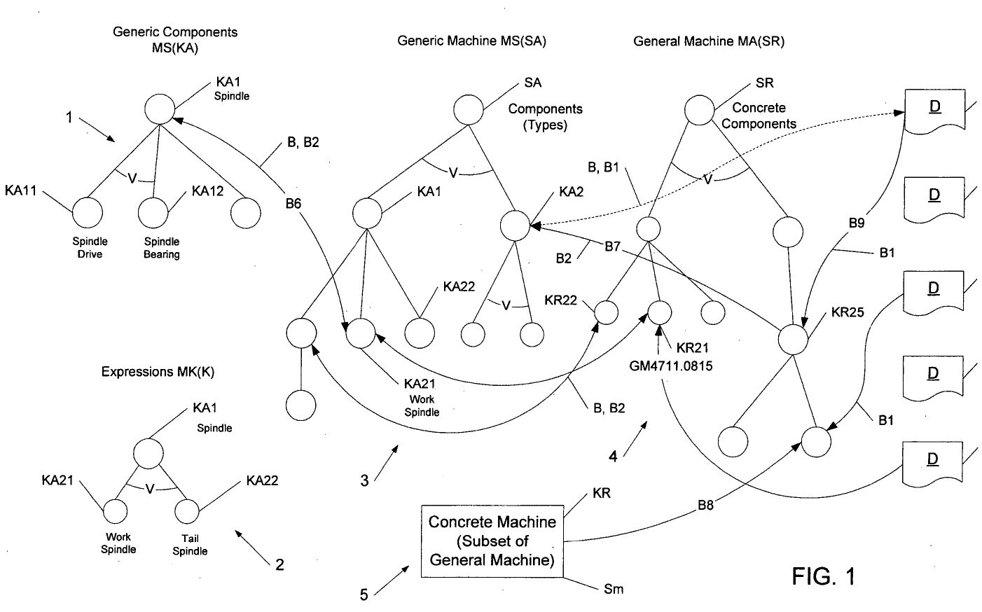

Turning now to the drawing, and in particular to FIG. 1, there is shown a schematic diagram of several models M for modeling a technical system S, for example a technical machine or a technical facility, that has several components K. The components K of the technical system S can include devices, assemblies, apparatuses, sensors, aggregates, drives, etc. or a combination thereof (not shown).

Several models M are provided for modeling the technical system S, e.g. a machine. The models M are subdivided into parent models MS (also referred to as generic models), which in turn are subdivided into component-related parent models MS(KA) and machine-related or system-related parent models MS(SA) (hereinafter referred to as abstract parent models MS(K), MS(KA)), and into application-specific models MA, which are also subdivided into component-related application-specific models MA(KR) and machine-related or system-related application-specific models MA(SR) (hereinafter referred to as concrete models MA(K), MA(SR)).

The component K of a component-related parent model MS(KA) represents basic components or generic components which are formed from basic components and/or basic assemblies and/or generic components or generic assemblies.

FIG. 1 shows an exemplary generic, or abstract, component KA1 representing a spindle (indicated by reference numeral 1). The abstract component KA1 includes in turn individual generic components and/or generic assemblies KA11, KA12, . . . , e.g. a Spindle Drive KA11 and a Spindle Bearing KA12.

An associated identification model MK(K), also referred to as Expression (indicated by reference numeral 2), describes a property, characteristic value, dimension, functionality, etc., of each abstract component KA. The expression of the abstract component KA1 (Spindle) in FIG. 1 is here described in more detail by the associated identification models MK(K) as “Work Spindle” KA21 and “Tail Spindle” KA22. These two generic subcomponents or partial components—Work Spindle KA21 and Tail Spindle KA22—are based on the underlying generic or abstract component KA1—the Spindle—and differ in part in the associated data elements D.

The totality of all generic or abstract components KA and hence their parent models MS(KA) and their identification models MK(K) form a database which hereinafter will be referred to as parent component base, since it includes generic components KA such as component types and assembly types. The parent component base is implemented as a first model-related memory Sm (not shown in detail). In addition, the application-specific models MA(KR) and MA(SR) are preferably also stored in the first model-related memory Sm. Alternatively, the first model-related memory Sm can be subdivided into a first memory (not shown) for the parent models MS(KA), MS(SA) and a memory (not shown) for the application-specific models MA(SR), MA(KR).

Various information of additional components KR, KA can be represented, whereby individual components KR, KA that are identical or similar can be grouped together. For example, all motors can advantageously be combined in one group and all valves in another group. A corresponding generic or abstract component type can be provided for all components KR, KA of a group which, for example, for motors can include information expressed as data elements D about power rating, RPM and the like, and for valves information about the valve lift.

These specialized abstract component types are based on the underlying general abstract component KA, e.g. the generic component, which is provided only for receiving Information relating to a plain text designation of the corresponding component KA. This leads to a hierarchical relationship within the abstract component types and components KA which in the context of programming environments, e.g. in so-called object-oriented programming, is referred to as “inheritance.” The term “inheritance” is hereinafter used in the same way as in programming environments and is generated with program code means so that the underlying general generic component or the abstract component KA transfers (“inherits”) all information to the specific additional derived abstract components KA or to concrete components KR. Accordingly, the generic components can become progressively more specialized along an “inheritance line.” This can result in a comprehensive collection of generic components which can be used to model even complex technical systems SA, SR.

In detail, a system-related parent model MS(SA) (also referred to as System Model; indicated by reference numeral 3) is automatically generated based on the component-related parent models MS(KA) and/or optionally based on the component-related identification models MK(K). In other words: The system-related parent model MS(SA) of the technical system S, for example for a generic machine, is set up like a construction kit with preconfigured, but changeable, expandable and extendible generic or abstract components KA. The system-related parent model MS(SA) includes only generic and hence abstract components KA that are included in the parent component base.

In addition to the selection of the abstract components KA from the parent component base, the system-related parent model MS(SA) or system or base model includes links V between individual generic or abstract components KA (component type or assembly type), for example to produce the functionality of the machine or the abstract system SA to be modeled.

Application-specific models MA(SR) of a technical real system SR (indicated by reference numeral 4) are automatically generated in addition to the parent models MS(S), MS(KA), wherein the application-specific models MA(SR) are based on a predetermined number of application-specific models MA(KR) or concrete components KR. FIG. 1 shows the system-related concrete model MA(SR) for a “General Machine” representing a technical system S. However, such “General Machine” cannot be realized in practice, because it would include, for example, all the variations of one or more concrete components KR that can be implemented in a concrete machine.

Another component-related application-specific model MA(KR) of the technical system S (not shown in detail in FIG. 1) can describe a more detail a concrete embodiment of the “General Machine” to be modeled. The component-related concrete model MA(KR) describes a “Concrete Machine” and hence represents a subset of the “General Machine” and therefore also the system-related concrete model MA(SR). In particular, the component-related concrete model MA(KR) ran be used to describe in detail a delivered concrete machine, for example in the form of parts lists.

The models M, i.e. the parent models MS(S), MS(K), the identification models MK(K) and/or the application-specific models MA(S), MA(K) are related to each other by relationships B, such as relationships B6, B7, B8, B9, in equivalent, superior and inferior levels. Different types of relationships B, such as B1, B2, exist for associating data elements D between the various models M, such as functions, characteristics, properties, dimensions and/or information, within the abstract system SA and/or the concrete system SR and on the different levels.

The abstract components KA of the “Generic Machine”, i.e. the abstract system SA, are based on the generic components or generic assemblies of the parent component base. The underlying relationship B6 between the abstract component KA1 of the component-related parent model MS(KA) and the abstract component KA21 of the system-related parent model MS(SA) is referred to as Expression Relationship such that the abstract component KA21 of the system S is an “expression of” the abstract component KA1 of the parent. The concrete components KR21 of the General Machine 4, i.e. of the concrete model MA(SR), are also based on abstract components KA of the Generic Machine, i.e. the system-related parent model MA(SA). The underlying relationship B7 is referred to as realization relationship such that the component KR25 of the real system SR is a “realization of” the abstract component KA2 of the abstract system SA, the “Generic Machine.”

In other words: a generic abstract component KA or a parent component can form a basis for one or more real or concrete components KR through the relationships B (B1, . . . , B9), wherein each of these real components KR is an instance of the generic abstract component KA.

The relationships B between the concrete “General Machine”, the concrete model MA(SR) and the associated concrete system SR, and the concrete component KR, i.e. the concrete model MA(KR), exist because the component elements of the concrete component KR represent a subset of the elements of the “General Machine”—the concrete system SR. The relationship B8 indicates the concrete components KR or elements in the “General Machine”—the concrete system SR—that are present or are not present.

Based on the models M that are related with each other through the relationships B (including the specific models MS(KA), MS(SA), MK(K), MA(SR), MA(KR)), the data elements D of a model M, e.g. a component-related parent model MS(KA), of a superior level is automatically associated with another model M, e.g. a system-related parent model MS(SA), that is related to this model M and located at an equivalent or inferior level, and vice versa.

The first model-related memory Sm is provided for storing the models M. The data elements D are stored in a second data-related to memorySd depending on the data configuration and structure. The second data-related memory Sd can also be implemented separately. Alternatively, the data elements D can also be stored in the corresponding first model-related memory Sm. The different data elements D are indicated by the same graphic symbols. The data elements D, i.e. their data sets, each include information, i.e. in particular useful information and metadata, for particular technical abstract and concrete components KA and KR, respectively. The information contained in the data elements D is, on one hand, associated with the model M at the highest level or the lowest level. On the other hand, the respective data element D is automatically associated with and referenced to the other models M that also relate to that data element D based on another relationship B2. I.e., depending on the arrangement of the levels, the data elements are associated based on the relationships B and starting from an initial level in a descending or ascending order. The data element D is preferably associated with a component KA or KR of the respective model M.

In other words: information, e.g. documentation for a component or feature, for example feature descriptions for a diagnostic system, which represent content of the data elements D, are no longer associated as data elements D with the concrete component KR or machine, but are instead associated with the superior level concrete system SR (=“General Machine”) or if the information can be generalized, with an abstract component KA (=“Generic Component”) or with an abstract technical system SA (=“Generic Machine”). By executing a generator, a model M for the concrete machine or component KR with the associated data elements D can be obtained by checking for each component KR, KA if a relationship B exists to an element in a different model MS(KA), MS(SA), MA(SR), MA(KR) having a superior or inferior abstraction level. If this is a case, then the data element D forming the basis of the respective relationship B of the respective model M, e.g. for a concrete component KR, with MS(KA), MS(SA), MA(SR), MA(KR), is transferred to a parts list for the other model M.

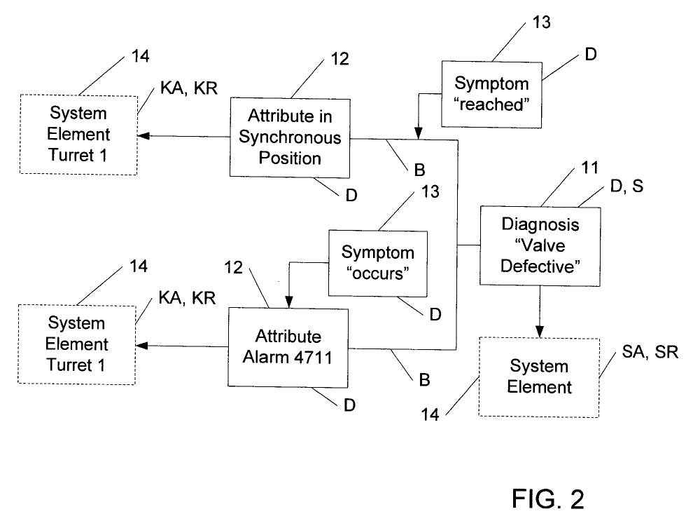

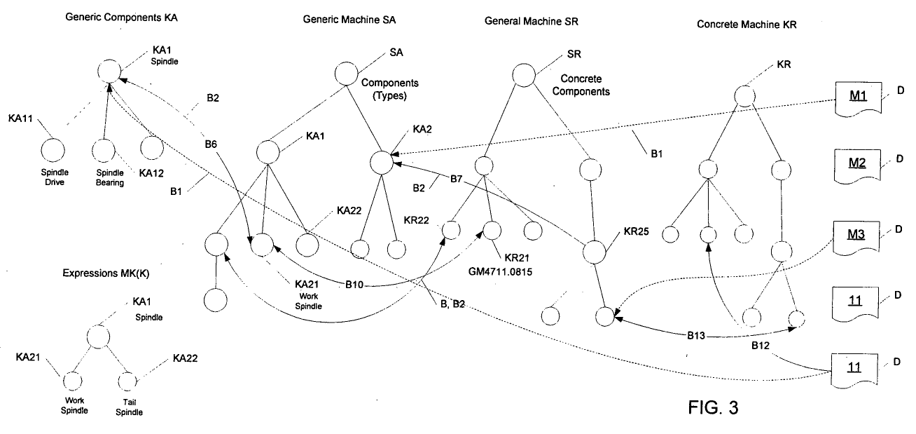

FIGS. 2 and 3 depicts examples for using the afore-described approach with generic models to derive from a generally applicable control mechanism for a concrete machine a control mechanism in connection with a diagnostic system for technical systems S, for example a machine tool. Details of an “iterative computer-aided diagnosis” are described, for example, in the afore-mentioned commonly owned US patent application with the title “Method and Device for Computer-Aided Analysis of a Technical System”.

Referring now to in FIG. 2, a control mechanism consists of a number of diagnoses 11 for a technical system S. Each diagnosis 11 is linked with a number of data elements D in the form of attributes 12 and symptoms 13, respectively Diaonoses 11 and attributes 12 are associated with system elements 14, e.g. components KR, KA of the technical system S. The diagnoses 11 can be represented based on the components KA, KR and hence based on generic components or generic assemblies as generic system S. In this way, a general control mechanism is created with a parent database, which in the context of this embodiment is referred to as diagnosis database. The general control mechanism can be transformed into an installation-specific control mechanism. The relationships B between the technical system S, i.e. a representation of a diagnosis 11, and a concrete or abstract component KR and KA, respectively, in particular a system element 14, are used for modeling an abstract parent model MS(SA) or a concrete model MR(SR), i.e. according to the equivalent of the “Generic Machine” or the “General Machine”, for automatically associating the data elements D, i.e. the attributes 12 and the symptoms 13. The attributes 12 and symptoms 13 are ordered accordingly, i.e. “inherited” or “reordered”, in the resulting tree.

The example depicted in FIG. 3 shows a diagnostic control mechanism for automatic association of data elements D. The attribute M1 is used as data element D. One of the diagnoses 11 (FIG. 2) is associated with an abstract component KA or parent component—the generic component “Spindle”. Through the relationship B1 the diagnoses 11 is associated with the abstract component KA as a data element D, based on which another relationship B6 between the component-related parent model MS(KA) and the system-related parent model MS(SA) is established. In this way, an association is created between the diagnosis 11 as data set of the abstract component KA—the “generic component”—and the abstract technical system SA where the abstract component KA is used as the “Work Spindle.” The relationship B6 automatically associates the data elements D of the abstract component KA with the abstract system-related parent model MS(SA).

Another relationship B10 indicates that the “work spindle”—the abstract component KA—is implemented by a concrete component or by a concrete part KR with a text designation “GM4711.0815” as a data element D. This concrete component KR exists also in the “Concrete Machine” or the concrete system SR. In this way, the diagnosis 11 can be associated with the concrete component KR designated as “GM4711.0815” of the installation parts list, based on a corresponding relationship B12.

It can happen in these transformations that individual diagnoses 11 representing equivalent representations of the attributes M1 to M3 are deleted because concrete components KR do not exist in the “Concrete Machine” or the concrete system SR (e.g., as a result of omitted options). One example is the attribute M3. A corresponding relationship B13 indicates that the part or the component KR having the associated attribute M3 does not exist in the “Concrete Machine” or the concrete system SR. The attribute M3 is therefore deactivated, as indicated by the dashed line. Alternatively, the attribute M3 can be deleted.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method for modeling a technical system with a plurality of technical components, comprising the steps of:
providing data elements of a plurality of models which have a pre-definable mutual relationship in equivalent, superior and/or inferior levels, and
based on the mutual relationship, automatically associating a data element of a first model located at a superior level with another model on an equivalent or inferior level that has a pre-definable relationship with the first model, and vice versa.

2. The method of claim 1, wherein each data element is associated with a single model.

3. The method of claim 1, wherein the models are subdivided into parent models and application-specific models.

4. The method of claim 3, wherein starting with an application-specific model, a concrete relationship, in particular a functional relationship, is created and associated between one of the parent models and the application-specific model.

5. The method of claim 1, and further comprising the step of automatically creating at least one model of the technical system based on a plurality of component models and their relationships.

6. The method of claim 3, wherein a parent model of the technical system is generated based on a parent model of one or more components.

7. The method of claim 3, wherein an application-specific model of the technical system is generated based on an application-specific model of one or more components.

8 A device for automatically associating data elements when modeling of a technical system having a plurality of components based on models which are located at equivalent, superior and/or inferior levels and have a mutual relationship, comprising
a first model-related memory for storing the models, and
a second data-related memory for storing the data elements,
wherein at least one relationship is associated with the models stored in the first model-related memory, based on which the corresponding data element that is stored in the second data-related memory is associated with a first model at a superior level, and
wherein based on a pre-definable relationship the corresponding data element of the first model at the superior level is automatically associated with another model located at an equivalent or inferior level and having a relationship with the first model.

9. The device of claim 8, and further comprising at least one program code means for creating and storing the pre-definable relationship between at least two models.

10. The device of claim 8, and further comprising an additional program code means for referencing and storing the data element representing the pre-definable relationship.

11. The device of claim 8, wherein the first model-related memory is subdivided into a memory for parent models and a memory for application-specific models.
